(19) United States
(12) Patent Application Publication
(10) Pub. No.: US 2026/0335937 A1
(43) Pub. Date: Oct. 29, 2026

(54) CONTROL DEVICE, FOREIGN MATTER REMOVAL DEVICE, COLLECTION APPARATUS, AND INFORMATION PROCESSING METHOD

(71) Applicant: FUJI CORPORATION, Chiryu (JP)

(72) Inventor: Hironori KONDO, Nagoya-shi (JP)

(73) Assignee: FUJI CORPORATION, Chiryu (JP)

(21) Appl. No.: 19/134,972

(22) PCT Filed: Dec. 20, 2022
(86) PCT No.: PCT/JP2022/046935

§ 371 Date: Jun. 2, 2025

(51) Int. Cl. B07C 5/36

(52) U.S. Cl. CPC B07C 5/36; B07C 2501/0063

(57) ABSTRACT

A control device of the present disclosure is used in a collection apparatus including a collection section configured to collect a target object with a collection member, and a sensing section configured to sense passage of the target object when the target object is accommodated in an accommodation section in which the target object collected by the collection section is stored. The control device is configured to obtain process information on collection movement success of the target object and/or collection movement failure of the target object based on collection information on the collection of the target object and sensing information of the target object sensed by the sensing section.

### TECHNICAL FIELD

The present description discloses a control device, a foreign matter removal device, a collection apparatus, and an information processing method.

### BACKGROUND ART

Conventionally, as a collection apparatus that collects a target object, for example, there has been proposed a collection apparatus including a turntable on which collected materials are scattered, and an extraction device that identifies the collected materials to specify placement positions of the collected materials and extracts the collected materials disposed on the turntable, in which the extraction device is configured to rotate in the same direction and at the same speed with reference to the same rotation center as a rotation center of the turntable (for example, refer to Patent Literature 1). In the collection apparatus, manufacturing cost can be reduced by reducing a size, and the collection apparatus can be applied to various waste and has high separation performance.

### CITATION LIST

### Patent Literature

Patent Literature 1:JP-A-2021-164903

### BRIEF SUMMARY

### Technical Problem

Meanwhile, in the apparatus of Patent Document 1, it is possible to count the number of target objects such as waste and calculate the number of target object that cannot be collected, but it has not been sufficiently studied to clarify work efficiency when collecting the target objects and improve the work efficiency.

The present disclosure has been made to solve such a problem, and a main object thereof is to provide a control device, a foreign matter removal device, a collection apparatus, and an information processing method with which it is possible to further improve work efficiency in collecting a target object and moving the target object to an accommodation section.

The present disclosure employs the following means in order to achieve the object described above.

That is, a control device according to the present description is
a control device for use in a collection apparatus including a collection section configured to collect a target object with a collection member, and a sensing section configured to sense passage of the target object when the target object is accommodated in an accommodation section in which the target object collected by the collection section is stored, the control device includes:
a control section configured to obtain process information on collection movement success of the target object and/or collection movement failure of the target object based on collection information on the collection of the target object and sensing information of the target object sensed by the sensing section.

In the control device, it is possible to detect that the target object is moved to the accommodation section by sensing the passage of the target object. Further, the control device can quantify information on collection success or collection failure of the target object without inspecting the collection member itself, by using the collection information on the collection of the target object and the sensing information of the target object sensed by the sensing section. Therefore, in the control device, it is possible to further improve work efficiency in collecting the target object and moving the target object to the accommodation section by using the quantified content.

### BRIEF DESCRIPTION OF DRAWINGS

FIG. 1 is a view showing an example of a configuration of recycling system 10.

FIG. 2 is a view showing an example of a schematic configuration of foreign matter removal device 30.

FIG. 3 is a perspective view showing an example of a schematic configuration of removal section 40.

FIG. 4 is a view showing an example of captured images 71 and 72 of detection section 31.

FIG. 5 is a view showing an example of information stored in storage section 52.

FIG. 6 is a flowchart showing an example of a foreign matter removal process routine.

FIG. 7 is a flowchart showing an example of a state estimation process routine.

FIG. 8 is a view showing an example of notification screen 80 displayed on display section 38.

FIG. 9 is a view showing an example of a configuration of collection system 10B.

### DESCRIPTION OF EMBODIMENTS

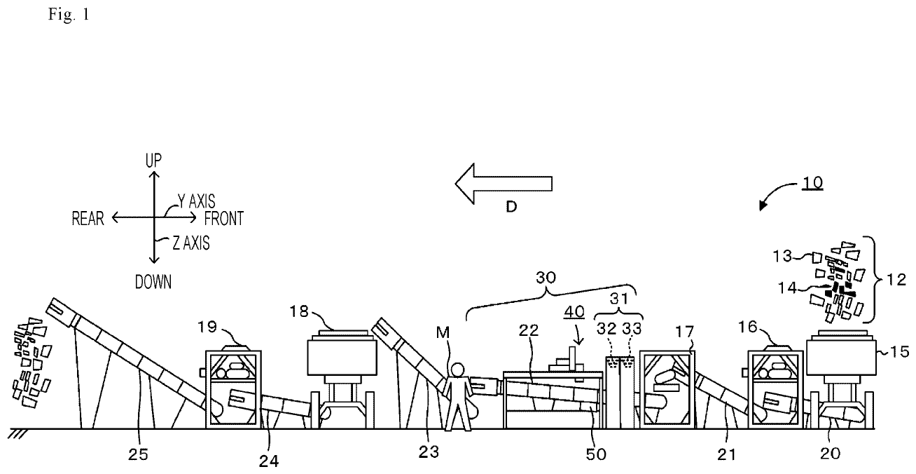

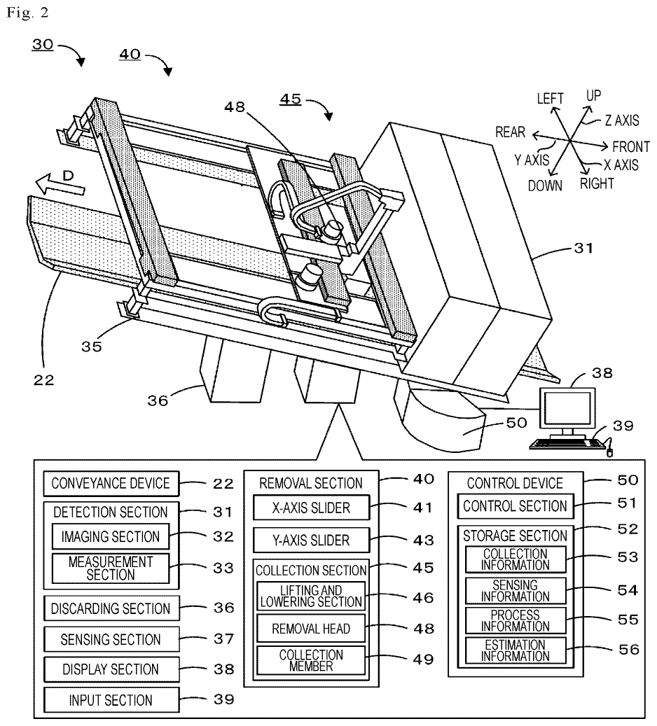

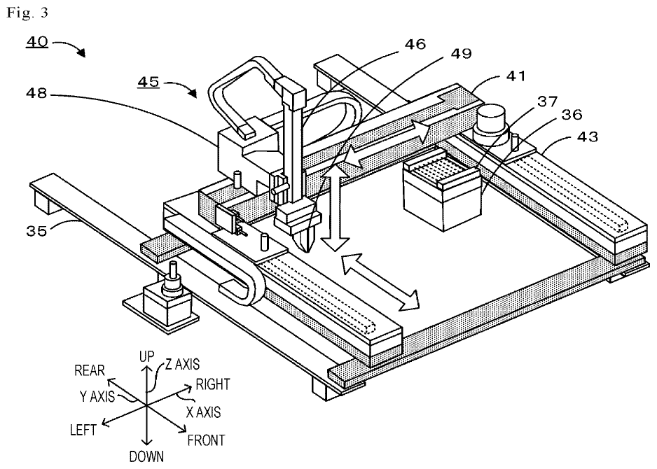

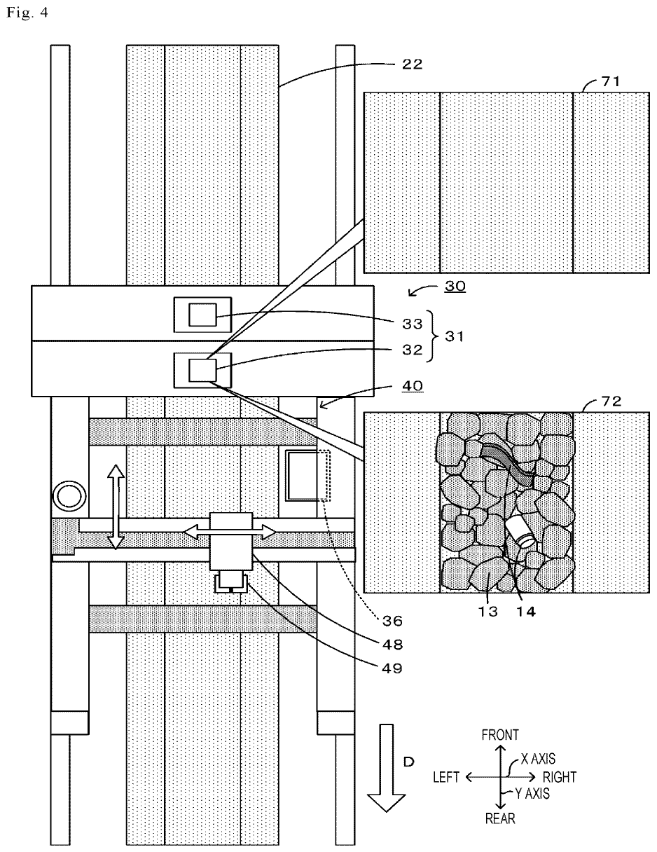

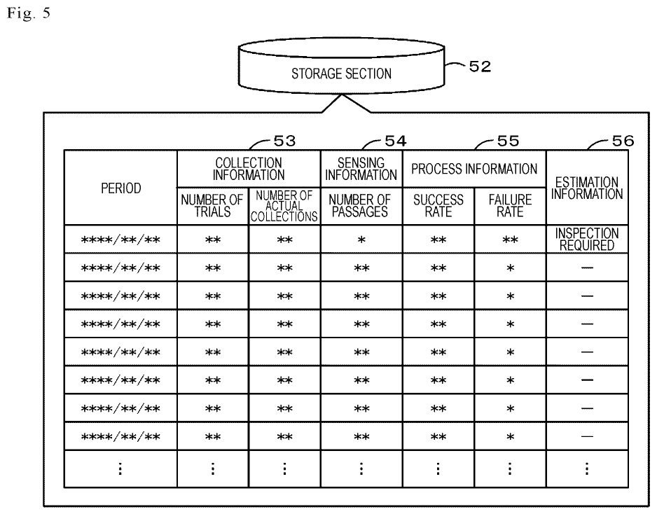

An embodiment of the present disclosure will be described with reference to the accompanying drawings. FIG. 1 is a view showing an example of a configuration of recycling system 10 for recycling a waste material, which is shown as an example of a collection system. FIG. 2 is a view showing an example of a schematic configuration of foreign matter removal device 30. FIG. 3 is a perspective view showing an example of a schematic configuration of removal section 40. FIG. 4 is a view showing an example of captured images 71 and 72 captured by detection section 31. FIG. 5 is a view showing an example of collection information 53, sensing information 54, process information 55, and estimation information 56 stored in storage section 52. In the present embodiment, a left-right direction, a front-rear direction, and an up-down direction will be described as shown in FIGS. 1 to 4. In the present embodiment, a direction in which process material 12 as a process target is conveyed is referred to as conveyance direction D.

Process material 12 as a target object that is processed by recycling system 10 is a mixture obtained by mixing waste material 13, which is a target for recycling such as stone, sand, and concrete, with foreign matter 14 including paper, resin, wood, metal, or the like. As shown in FIG. 1, recycling system 10 includes primary crusher 15, primary magnetic separator 16, screening machine 17, foreign matter removal device 30, secondary crusher 18, secondary magnetic separator 19, and conveyance devices 20 to 25.

Primary crusher 15 is a device that primarily crushes process material 12 as a raw material. Primary crusher 15 crushes process material 12 such that process material 12 has a size equal to or smaller than a predetermined primary size (for example, 40 cm or less), for example. Primary magnetic separator 16 is a device that removes a foreign matter which is magnetic material contained in process material 12 by a magnetic force. Screening machine 17 is a device that separates process material 12 having a size equal to or larger than the primary size and process material 12 having a size smaller than the primary size by process material 12 passing above a mesh, for example. Secondary crusher 18 is a device that secondarily crushes process material 12 to a size smaller than that in primary crusher 15. Secondary crusher 18 crushes process material 12 such that process material 12 has a size equal to or smaller than a predetermined secondary size or less (for example, 10 cm or less). Secondary magnetic separator 19 is a device that removes, from process material 12, the magnetic material not removed by primary magnetic separator 16 and foreign matter removal device 30.

Conveyance devices 20 to 25 as conveyance lines are devices that place process material 12 on a conveyance surface and convey process material 12 along conveyance direction D, and are configured as, for example, belt conveyors. Conveyance devices 20 to 25 may have configurations other than the belt conveyor as long as process material 12 is conveyed.

Foreign matter removal device 30 is configured as a collection apparatus that collects a target object, and is a device that places process material 12 on the conveyance surface of conveyance device 22, conveys process material 12 in the conveyance line, and collects and removes foreign matter 14. As shown in FIG. 2, foreign matter removal device 30 includes detection section 31, removal section 40, and control device 50. Foreign matter removal device 30 includes discarding section 36. Conveyance device 22 places process material 12 on the conveyance surface and conveys process material 12 at a predetermined conveyance speed.

Detection section 31 is a device that detects waste material 13 and foreign matter 14. Detection section 31 is disposed upstream of removal section 40 in conveyance direction D. Detection section 31 includes imaging section 32 that captures an image of process material 12 including waste material 13 and foreign matter 14 conveyed by conveyance device 22, and measurement section 33 that measures a height of process material 12. Imaging section 32 is configured as, for example, a camera that captures an image of process material 12 placed on the conveyance surface of conveyance device 22 and conveyed. Image section 32 captures an image of a predetermined range including process material 12 from above the conveyance surface of conveyance device 22, and outputs image data to control device 50. As shown in FIG. 4, imaging section 32 captures captured images 71 and 72 including waste material 13 and foreign matter 14. Captured image 71 is an example of an image in a state where process material 12 is not conveyed on conveyance device 22. Captured image 72 is an example of an image in a state where process material 12 or foreign matter 14 is conveyed on conveyance device 22. Measurement section 33 measures the height of process material 12 or the like on conveyance device 22. For example, measurement section 33 may be provided upstream of removal section 40 in conveyance direction D, and may be configured as a stereo camera including two cameras. Alternatively, measurement section 33 may be a sensor that detects a reflected wave obtained by irradiating the conveyance surface to obtain a height of a reflection position. Imaging section 32 and measurement section 33 are held above the conveyance surface of conveyance device 22 by a holding member provided to straddle conveyance device 22 in the left-right direction. Measurement section 33 outputs information on the detected height of process material 12 to control device 50. Note that foreign matter removal device 30 including measurement section 33 can perform conveyance control of process material 12 using the information on a height direction of process material 12. Meanwhile, either imaging section 32 or measurement section 33 may be omitted in foreign matter removal device 30 as long as the height of process material 12 can be measured.

Discarding section 36 is a dust box as an accommodation section that accommodates foreign matter 14. Foreign matter 14 collected by collection section 45 of removal section 40 is dropped into discarding section 36. Note that discarding section 36 may include multiple accommodation containers and may perform separation according to the weight and material of foreign matter 14. Sensing section 37 that senses the dropped object is disposed at an opening edge of discarding section 36. Sensing section 37 is configured as a device that senses passage of foreign matter 14 when foreign matter 14 is accommodated in discarding section 36 in which foreign matter 14 is stored. Sensing section 37 may be, for example, a sensor capable of detecting a passing object, for example, a non-contact sensor. Sensing section 37 may be an area sensor having an entire opening of discarding section 36 as a detection region. The non-contact sensor may include, for example, an irradiation section that emits infrared rays or laser light, and a light receiving section that detects the emitted direct light or reflected light. Alternatively, sensing section 37 may capture an image of the entire opening of discarding section 36 and detect passage of an object from the captured image.

Removal section 40 is a device that collects and removes, with collection member 49, a target object such as foreign matter 14 contained in process material 12 conveyed by conveyance device 22 in conveyance direction D. Removal section 40 is configured as, for example, an XY robot. Removal section 40 detects and removes foreign matter 14 present in process material 12 based on the captured image captured by imaging section 32. Removal section 40 is provided downstream of detection section 31 in conveyance direction D. Removal section 40 includes X-axis slider 41, Y-axis slider 43, and collection section 45. Removal section 40 discards collected foreign matter 14 to discarding section 36 disposed on a side of conveyance device 22. Removal section 40 may have another configuration such as an articulated arm robot.

X-axis slider 41 includes a drive mechanism. Drive mechanism 4 includes a guide rail installed along a direction orthogonal to conveyance direction D of conveyance device 22, a slider that moves along the guide rail, and a drive motor that drives the slider. The guide rail is fixed to a slider of Y-axis slider 43 installed on conveyance device 22 along conveyance direction D. Removal head 48 provided with lifting and lowering section 46 is fixed to the slider of X-axis slider 41. The drive mechanism may be, for example, a linear motion mechanism using a ball screw including a screw shaft and a nut. The drive mechanism is not particularly limited as long as it is a linear motion mechanism, and may be a linear motor or the like. In X-axis slider 41, removal head 48 is moved by the drive mechanism along an X-axis direction. Y-axis slider 43 includes a drive mechanism. The drive mechanism includes a guide rail installed along conveyance direction D, a slider that moves along the guide rail, and a drive motor that drives the slider. The guide rail is fixed to support portion 35 installed on conveyance device 22 along conveyance direction D. X-axis slider 41 is disposed on the slider of Y-axis slider 43. In Y-axis slider 43, X-axis slider 41 is moved by the drive mechanism along a Y-axis direction.

Collection section 45 is a unit that collects an object such as foreign matter 14 with collection member 49, and includes, for example, lifting and lowering section 46, removal head 48, and collection member 49. Lifting and lowering section 46 is a drive mechanism fixed to removal head 48 disposed on X-axis slider 41, and lifts and lowers collection member 49 along a Z-axis direction. The drive mechanism may be a mechanism similar to the drive mechanism of X-axis slider 41 or Y-axis slider 43. A camera and/or a sensor is disposed in collection section 45, and is configured to acquire information of foreign matter 14 gripped by collection member 49. Collection member 49 is a member that collects an object, and may be a gripping claw that grips an object. Alternatively, collection member 49 may be a suction nozzle that picks up an object by a negative pressure. Collection section 45 grips foreign matter 14 and releases the gripping of foreign matter 14 by opening and closing operations of collection member 49 to collect and remove foreign matter 14 from process material 12. Collection section 45 opens and closes collection member 49 by a gripping drive section (not shown). Collection member 49 is moved in X, Y, and Z directions within a predetermined range of conveyance device 22 by X-axis slider 41, Y-axis slider 43, and lifting and lowering section 46.

Control device 50 is a device that controls entire foreign matter removal device 30, and includes control section 51 and storage section 52. Control section 51 is configured as a microprocessor mainly including CPU, and controls the entire device. Control section 51 outputs control signals to detection section 31 and removal section 40, and inputs signals from detection section 31 and removal section 40. Storage section 52 is a storage medium for storing information and includes, for example, an HDD or a flash memory. As shown in FIG. 5, storage section 52 stores, for example, collection information 53, sensing information 54, process information 55, estimation information 56, and the like. Collection information 53 is information on the collection of foreign matter 14 as a target object, and includes, for example, the number of trials of a collection process, the number of actual collections in which foreign matter 14 was actually collected, and the like. Sensing information 54 is information on foreign matter 14 sensed by sensing section 37, and includes the number of passages in which foreign matter 14 passed to the accommodation section of discarding section 36. Process information 55 is information on collection movement success of foreign matter 14 and/or collection movement failure of foreign matter 14, and includes, for example, a success rate, a failure rate, a success number, a failure number, and the like of collection movement of foreign matter 14. Estimation information 56 includes a state of collection member 49, for example, at least one of an inspection-required state in which inspection is required, a maintenance-required state in which maintenance is required, and a repair-required state in which repair is required by a malfunction diagnosis. In control device 50, collection information 53, sensing information 54, process information 55, and estimation information 56 are associated with each other for each period, for example, every hour, every day, or every week. Based on collection information 53 and sensing information 54, control section 51 executes a process of obtaining process information 55 on the collection movement success of foreign matter 14 and/or the collection movement failure of foreign matter 14. Alternatively, control section 51 outputs estimation information 56 in which the state of collection member 49 is estimated based on collection information 53 and sensing information 54.

Display section 38 and input section 39 are connected to control device 50. Display section 38 is a display for displaying an image. Input section 39 receives input from worker M, and includes a keyboard, a mouse, or the like.

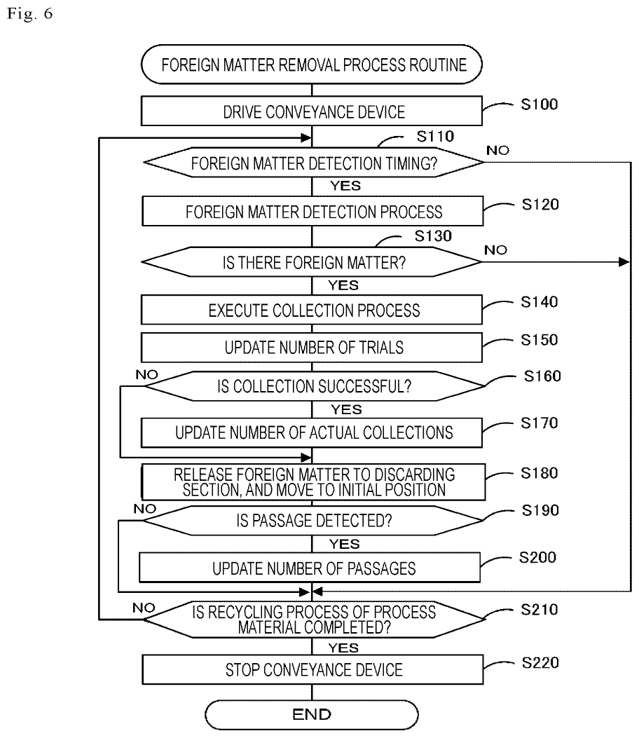

Next, an operation of foreign matter removal device 30 configured as described above will be described. First, a process of removing foreign matter 14 from process material 12 to produce waste material 13 will be described. Note that, in foreign matter removal device 30, detection section 31 is described as a section constantly performing an image capturing process of a captured image with imaging section 32 and height sensing with measurement section 33. Note that detection section 31 may appropriately perform the image capturing process and the height sensing at every predetermined timing instead of constantly performing the image capturing process and the height sensing. FIG. 6 is a flowchart showing an example of a foreign matter removal process routine executed by control section 51 of control device 50. The routine is stored in storage section 52, and is executed by control section 51 after foreign matter removal device 30 is activated. When the routine is started, control section 51 first drives conveyance device 22 (S100), and determines whether it is a foreign matter detection timing (S110). It is assumed that imaging section 32 captures an image of the entire process material 12 conveyed by conveyance device 22 as a seamless still image, and the foreign matter detection timing may be, for example, a timing at which the still image changes to the next image. When imaging section 32 captures a moving image, a detection timing may be a time when a certain period of time for acquiring a still image elapses. In addition, the detection timing in measurement section 33 may be, for example, every elapse of a certain time or may be the same as the detection timing of imaging section 32.

When it is the foreign matter detection timing in S110, control section 51 acquires the captured image captured by imaging section 32, acquires a height value measured by measurement section 33, and performs a detection process of waste material 13 and foreign matter 14 using the captured image and the height value (S120). As the detection process of waste material 13, control section 51 performs, for example, a process of detecting a region having luminance different from that of the conveyance surface of conveyance device 22 and setting the region as a region of waste material 13. In addition, control section 51 may obtain a region of waste material 13 from the acquired height of the conveyance surface. Further, control section 51 can determine presence or absence of foreign matter 14 based on, for example, whether a region of foreign matter 14 is present in the captured image (refer to FIG. 4).

Next, control section 51 determines whether foreign matter 14 is present in the captured image of conveyance device 22 (S130). When foreign matter 14 is present in conveyance device 22, control section 51 executes the collection process of foreign matter 14 (S140). In the collection process of foreign matter 14, control section 51 sets a movement path for collecting foreign matter 14 and releasing foreign matter 14 in discarding section 36, moves collection member 49 to a position at which foreign matter 14 is present in accordance with a movement speed of foreign matter 14, and collects foreign matter 14. When the collection process of foreign matter 14 is executed, control section 51 increments the number of trials to collect foreign matter 14 by 1 to update the number of trials in a corresponding period included in collection information 53 (S150), and determines whether the collection of foreign matter 14 is successful using the captured image, a sensor output value, or the like of collection member 49 (S160). When the collection of foreign matter 14 using collection member 49 is successful, control section 51 increments the number of actual collections of collection information 53 by 1 to update the number of actual collections in a corresponding period (S170).

After S170 or after collection member 49 does not succeed in collecting foreign matter 14 in S160, control section 51 moves collection member 49 to a release position of foreign matter 14 set on discarding section 36, releases foreign matter 14, and moves collection member 49 to a planned initial position (S180). Control section 51 determines whether the passage of foreign matter 14 is detected based on a detection signal from sensing section 37 disposed in discarding section 36 (S190). When the passage of foreign matter 14 is detected, control section 51 increments the number of passages included in sensing information 54 by 1 to update the number of passages in a corresponding period (S200).

After S200, when there is no foreign matter 14 in S130, or when it is not the foreign matter detection timing in S110, control section 51 determines whether a recycling process of process material 12 is completed (S210). When the recycling process of process material 12 is not completed, control section 51 repeatedly executes the processes of S110 and the subsequent steps. That is, control section 51 repeatedly executes the process of removing foreign matter 14 while detecting foreign matter 14 and updating the number of trials, the number of actual collections, the number of passages, and the like. Meanwhile, when the recycling process of process material 12 is completed in S210, control section 51 stops conveyance device 22 (S220) and ends the routine.

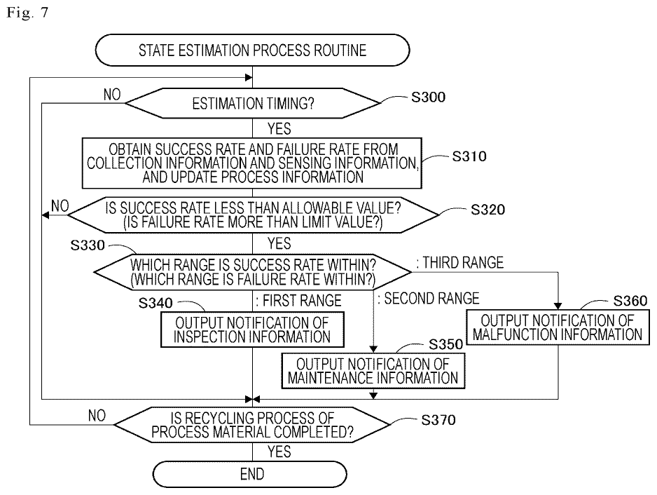

Next, a process in which control section 51 estimates the state of collection member 49 will be described. FIG. 7 is a flowchart showing an example of a state estimation process routine executed by control section 51 of control device 50. The routine is stored in storage section 52, and is executed in parallel with the execution of the foreign matter removal process routine after foreign matter removal device 30 is activated. When the routine is started, control section 51 first determines whether it is an estimation timing for estimating the state of collection member 49 (S300). The estimation timing may be any timing as long as the state of collection member 49 can be appropriately determined, and may be set to, for example, a time when a period of information stored in storage section 52 elapses. When it is currently the estimation timing, control section 51 obtains the success rate and/or the failure rate for collecting foreign matter 14 based on latest collection information 53 and latest sensing information 54, and updates the process information (S310). For example, control section 51 can obtain the success rate from following Expression 1 or Expression 2. Alternatively, control section 51 can obtain the failure rate from following Expression 3 or Expression 4. For the success rate and the failure rate, when the number of actual collections is used, it is possible to obtain information on falling of foreign matter 14 from the collection to the release of foreign matter 14, and when the number of trials is used, it is possible to obtain information on the falling from the collection failure to the release of foreign matter 14. When the success rate and the failure rate are obtained using the number of trials, a configuration for detecting the collection success of foreign matter 14 can be omitted from foreign matter removal device 30. Further, process information 55 may include the number of successes in addition to or instead of the success rate. Similarly, process information 55 may include the number of failures in addition to or instead of the failure rate. The number of successes is represented by the number of passages, and the number of failures is a value obtained by subtracting the number of passages from the number of trials or the number of actual collections.

Success rate (%)=100−(Number of trials−Number of passages)/(Number of trials)×100 (Expression 1)

Success rate (%)=100−(Number of actual collections−Number of passages)/(Number of actual collections)×100 (Expression 2)

Failure rate (%)=(Number of trials−Number of passages)/(Number of trials)×100 (Expression 3)

Failure rate (%)=(Number of actual collections−Number of passages)/(Number of actual collections)×100 (Expression 4)

Next, control section 51 determines whether the obtained success rate falls below a predetermined allowable value (S320). Here, the allowable value may be empirically set to a value at which it can be predicted that collection member 49 is defective. Here, as a range of the allowable value, a first range requiring inspection (for example, a success rate of less than 95%), a second range requiring maintenance (for example, a success rate of less than 90%), a third range requiring repair (for example, a success rate of less than 85%), and the like are defined. Next, control section 51 checks which range of which allowable value the success rate is within (S330), and when the success rate is within the first range, causes display section 38 to display and output inspection information as the estimation information of collection member 49 (S340). The inspection information includes information for prompting execution of inspection of collection member 49. Meanwhile, when the success rate is within the second range in S330, control section 51 causes display section 38 to display and output maintenance information as the estimation information of collection member 49 (S350). The maintenance information includes information for prompting execution of maintenance of collection member 49. Alternatively, when the success rate is within the third range in S330, display section 38 is caused to display and output malfunction information as the estimation information of collection member 49 (S360). The malfunction information includes information for prompting execution of repair of collection member 49.

In S320, control section 51 determines whether the obtained success rate falls below the predetermined allowable value, but the present disclosure is not particularly limited thereto, and control section 51 may determine whether the obtained failure rate exceeds a predetermined limit value. Here, the limit value may be empirically set to a value at which it can be predicted that collection member 49 is defective. Here, as a range of the limit value, a first range requiring inspection (for example, a failure rate of more than 5%), a second range requiring maintenance (a failure rate of more than 10%), a third range requiring repair (a failure rate of more than 15%), and the like are defined. Then, as described above, when the failure rate exceeds the predetermined limit value, control section 51 may determine whether the failure rate is within the first range, the second range, or the third range, display and output the inspection information in the first range, display and output the maintenance information in the second range, and display and output the malfunction information in the third range.

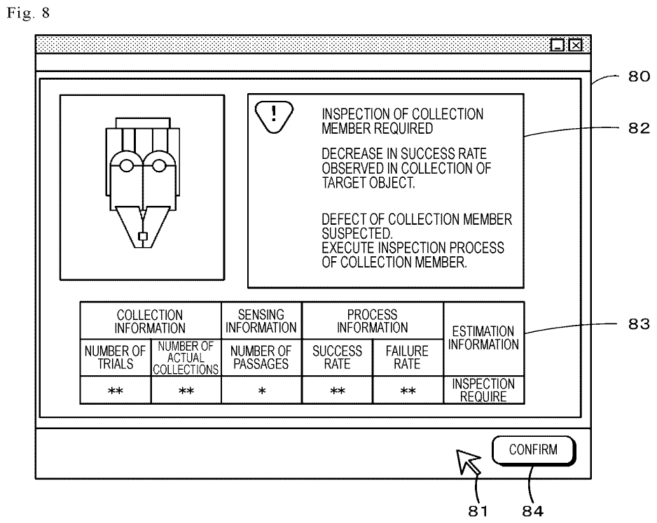

FIG. 8 is a view showing an example of notification screen 80 displayed on display section 38. Cursor 81, estimation information display field 82, process information display field 83, confirmation key 84, and the like are laid out on notification screen 80. Cursor 81 is operated by worker M when information is selected. Estimation information display field 82 includes information in which the state of collection member 49 is estimated, the content of work to be performed, and the like. Process information display field 83 includes information such as current collection information 53, sensing information 54, process information 55, and estimation information 56. Confirmation key 84 is a key pressed by worker M after display information is confirmed. Although a configuration in which the inspection information is displayed on notification screen 80 in FIG. 8 is described, notification screen 80 may display the maintenance information, the malfunction information, and the like. Worker M can confirm the content of notification screen 80, recognize the state of collection member 49, and confirm the state of collection member 49.

In foreign matter removal device 30, collection member 49 that grips waste material 13 such as debris and foreign matter 14 has a large risk of breakage. Examples of the breakage of collection member 49 include wear and cracking of a contact surface caused by contact with waste material 13. Meanwhile, the breakage of collection member 49 may be detected by capturing an image of collection member 49 with a camera or the like or by bringing collection member 49 into contact with a contact sensor or the like. However, in any of the above methods, an additional device such as a camera or a sensor is required, and a confirmation operation needs to be performed during operation, which may reduce efficiency of the process of removing foreign matter 14. In foreign matter removal device 30, the state of collection member 49 can be estimated by detecting the number of trials of removal and the number of actual collections of collection member 49, and the number of passages of discarding section 36, which are normally configured to be countable. For example, when the success rate of removing foreign matter 14 gradually decreases, control section 51 can estimate a state such as wear of collection member 49, and can prompt worker M to perform inspection or maintenance. Alternatively, when the success rate of removing foreign matter 14 rapidly decreases, control section 51 can estimate a malfunction state such as breakage of collection member 49, and can prompt worker M to repair the breakage. Even when the failure rate is used, control section 51 can estimate the state of collection member 49 similarly to the success rate.

After the notification of the information is output in S340 to S360, when the success rate is equal to or more than the allowable value in S320, or when it is not the estimation timing in S300, control section 51 determines whether the recycling process of process material 12 is completed (S370). When the recycling process of process material 12 is not completed, control section 51 executes the processes of S300 and the subsequent steps. That is, when it is the estimation timing, control section 51 notifies worker M of the information on the state of collection member 49 estimated based on process information 55 while updating process information 55 and the like. Meanwhile, when the recycling process of process material 12 is completed in S370, control section 51 ends the routine.

Here, a correspondence relationship between the elements of the present embodiment and the elements of the present disclosure will be clarified. Control device 50 of the present embodiment corresponds to an example of a control device of the present disclosure, foreign matter removal device 30 corresponds to an example of a collection apparatus and a foreign matter removal device, collection section 45 corresponds to an example of a collection section, discarding section 36 corresponds to an example of an accommodation section, sensing section 37 corresponds to an example of a sensing section, and control section 51 corresponds to an example of a control section. Conveyance device 22 corresponds to an example of a conveyance device, and process material 12 corresponds to an example of a target object. In the present embodiment, an example of an information processing method of the present disclosure is also clarified by describing the operation of foreign matter removal device 30.

Foreign matter removal device 30 described above is configured as the collection apparatus of the present disclosure, and includes collection section 45 configured to collect foreign matter 14 as the target object with collection member 49, foreign matter 14 being included in process material 12 conveyed by conveyance device 22 in conveyance direction D, sensing section 37 configured to sense passage of foreign matter 14 when foreign matter 14 is accommodated in discarding section 36 as the accommodation section in which foreign matter 14 collected by collection section 45 is stored, detection section 31 provided upstream of collection section 45 in conveyance direction D and configured to detect foreign matter 14, and control device 50 including control section 51, in which control section 51 is configured to control collection section 45 based on a detection result of detection section 31 such that foreign matter 14 is collected and discarded to discarding section 36. Further, control section 51 obtains process information 55 on collection movement success of foreign matter 14 and/or collection movement failure of the foreign matter 14 based on collection information 53 on the collection of foreign matter 14 and sensing information 54 of foreign matter 14 sensed by sensing section 37. In control device 50, it is possible to detect that foreign matter 14 is moved to discarding section 36, by sensing the passage of foreign matter 14. In addition, by using collection information 53 and sensing information 54, control device 50 can quantify the information on the collection success or the collection failure of foreign matter 14 without inspecting collection member 49 itself. Therefore, in control device 50, it is possible to estimate the state of collection member 49 by using the quantified content, and it is possible to further improve the work efficiency in collecting the target object and moving the target object to the accommodation section.

Control section 51 outputs estimation information 56 in which the state of collection member 49 is estimated based on collection information 53 and sensing information 54. In control device 50, it is possible to detect that foreign matter 14 is moved to discarding section 36, by sensing the passage of foreign matter 14. Further, control device 50 can acquire the information on the collection success or collection failure of foreign matter 14 using collection member 49 without inspecting collection member 49 itself, by using collection information 53 of foreign matter 14, and estimate the state of collection member 49. Therefore, in control device 50, it is possible to further improve the work efficiency in collecting foreign matter 14 and moving foreign matter 14 to discarding section 36, by using the estimated state of collection member 49. Further, control section 51 outputs estimation information 56 in which the state of collection member 49 is estimated based on obtained process information 55. In control device 50, it is possible to estimate the state of collection member 49 without inspecting collection member 49 itself, by using the information on the collection success or collection failure of foreign matter 14. In control device 50, it is possible to further improve the work efficiency in collecting foreign matter 14 and moving foreign matter 14 to discarding section 36, by taking measures according to the state of collection member 49. Furthermore, control section 51 uses collection information 53 including the number of trials to try to collect foreign matter 14 and/or the number of actual collections in which it was detected that foreign matter 14 was collected. In control device 50, it is possible to further improve the work efficiency in collecting foreign matter 14 and moving foreign matter 14 to discarding section 36, by using the number of trials or the number of actual collections.

Control section 51 obtains process information 55 including the success rate and/or the success number from collection information 53 and sensing information 54. In control device 50, it is possible to further improve the work efficiency in collecting foreign matter 14 and moving foreign matter 14 to discarding section 36, by using the success rate and the success number of the collection process. In control device 50, control section 51 outputs estimation information 56 in which the state of collection member 49 is estimated when the obtained success rate and/or the obtained success number falls below the predetermined allowable value. Further, control section 51 obtains process information 55 including the failure rate and/or the failure number from collection information 53 and sensing information 54. In control device 50, it is possible to further improve the work efficiency in collecting foreign matter 14 and moving foreign matter 14 to discarding section 36, by using the failure rate or the failure number of the collection process. In control device 50, control section 51 outputs estimation information 56 in which the state of collection member 49 is estimated when the obtained failure rate and/or the obtained number of failures exceeds the predetermined limit value. Furthermore, control section 51 outputs estimation information 56 including at least one of malfunction information including the malfunction diagnosis of collection member 49, maintenance information for executing maintenance of collection member 49, and inspection information for executing inspection of collection member 49. In the control device, by further improving the state of the collection member using the malfunction information, the maintenance information, and the inspection information, it is possible to further improve the work efficiency in collecting the target object and moving the target object to the accommodation section.

It is needless to say that the present disclosure is not limited to the embodiment described above in any way, and hence can be implemented in various aspects as long as the aspects fall within the technical scope of the present disclosure.

For example, in the above-described embodiment, control section 51 obtains process information 55 on the collection movement success of foreign matter 14 and the collection movement failure of foreign matter 14 based on collection information 53 and sensing information 54, and outputs notification of estimation information 56 based on process information 55, but the present disclosure is not particularly limited thereto, and either obtaining process information 55 or outputting notification of estimation information 56 may be omitted. In addition, control section 51 obtains process information 55 on the collection movement success of foreign matter 14 and the collection movement failure of foreign matter 14, but the present disclosure is not particularly limited thereto, and either the collection movement success or the collection movement failure of foreign matter 14 may be omitted. Even in control device 50 as described above, it is possible to further improve the work efficiency in collecting foreign matter 14 and moving foreign matter 14 to discarding section 36 by any of the processes.

In the above-described embodiment, collection information 53 includes the number of trials and the number of actual collections, but the present disclosure is not particularly limited thereto, and any one of the numbers may be omitted. In addition, in the above-described embodiment, estimation information 56 includes the malfunction information, the maintenance information, and the inspection information, but is not particularly limited thereto, and any one or more of these may be omitted. Even in this control device 50, it is possible to further improve the work efficiency in collecting foreign matter 14 and moving foreign matter 14 to discarding section 36 by any of the processes.

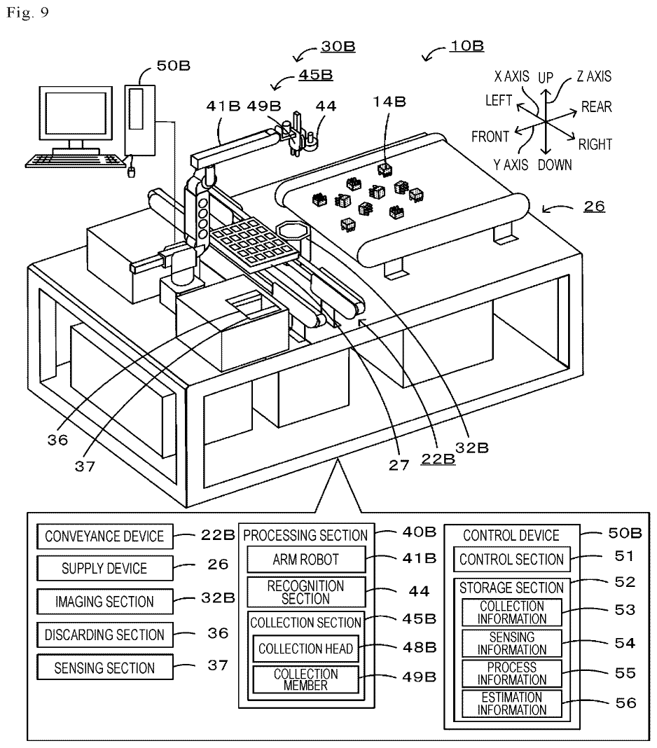

In the above-described embodiment, foreign matter removal device 30 that removes foreign matter 14 has been mainly described as the collection apparatus, but the collection apparatus is not particularly limited thereto. FIG. 9 is a view showing an example of a configuration of another collection system 10B. Collection system 10B includes conveyance device 22B, supply device 26, collection apparatus 30B, discarding section 36, and sensing section 37. Collection apparatus 30B includes sensing section 37 disposed in discarding section 36, processing section 40B including collection section 45B, and control device 50B including control section 51. Collection apparatus 30B is a device that performs a process of disposing a component as target object 14B disposed in supply device 26 on disposition member 27 to be conveyed by conveyance device 22B. Collection apparatus 30B determines presence or absence of a defect of target object 14B based on an image captured by imaging section 32B, and discards target object 14B having the defect to discarding section 36. Discarding section 36 is an accommodation section in which target object 14B collected by collection section 45B is stored. Sensing section 37 is a sensor that senses passage of target object 14B when target object 14B is accommodated in discarding section 36. Collection section 45B collects target object 14 with collection member 49B. Collection section 45B includes arm robot 41B, recognition section 44, and collection section 45B. Arm robot 41B includes multiple arm sections, and moves collection section 45B between supply device 26, conveyance device 22B, and discarding section 36. Recognition section 44 is disposed in collection section 45B and captures an image of target object 14B and the like on supply device 26. Collection section 45B includes collection head 48B disposed at a distal end of arm robot 41B, and collection member 49B mounted to collection head 48B and including a gripping claw. Similarly to control device 50 described above, control device 50B also obtains process information 55 or outputs notification of estimation information 56 based on collection information 53 and sensing information 54. Since collection apparatus 30B includes control device 50B described above, it is possible to further improve the work efficiency in collecting target object 14B and moving target object 14B to discarding section 36 as the accommodation section. Even in this collection apparatus 30B, it is possible to further improve the work efficiency in collecting target object 14B and moving target object 14B to discarding section 36.

In the above-described embodiment, the target object is discarded to discarding section 36, but the present disclosure is not particularly limited to the discarding, and the number of passages may be counted when the target object is accommodated in the accommodation section. Even in the collection apparatus, it is possible to further improve the work efficiency in collecting the target object and moving the target object to the accommodation section.

In the above-described embodiment, the present disclosure has been described as foreign matter removal device 30 including control device 50, but the present disclosure is not particularly limited thereto, and the present disclosure may be control device 50 itself, a control method of foreign matter removal device 30 executed by a computer, a program of the control method, an information processing method executed by control device 50, or a program of the information processing method.

Here, the control device of the present disclosure may be configured as follows. For example, the control device of the present disclosure is a control device for use in a collection apparatus including a collection section configured to collect a target object with a collection member, and a sensing section configured to sense passage of the target object when the target object is accommodated in an accommodation section in which the target object collected by the collection section is stored, the control device includes:
a control section configured to output estimation information in which a state of the collection member is estimated based on collection information on the collection of the target object and sensing information of the target object sensed by the sensing section.

In the control device, it is possible to detect that the target object is moved to the accommodation section by sensing the passage of the target object. Further, the control device can acquire the information on the collection success or the collection failure of the target object using the collection member without inspecting the collection member itself, and estimate the state of the collection member, by using the information on the collection of the target object. Therefore, in the control device, it is possible to further improve the work efficiency in collecting the target object and moving the target object to the accommodation section, by using the estimated state of the collection member.

The information processing method of the present disclosure is an information processing method to be executed by a computer, the information processing method being for use in a collection apparatus including a collection section configured to collect a target object with a collection member, and a sensing section configured to sense passage of the target object when the target object is accommodated in an accommodation section in which the target object collected by the collection section is stored, the information processing method includes:
a step of obtaining process information on collection movement success of the target object and/or collection movement failure of the target object based on collection information on the collection of the target object and sensing information of the target object sensed by the sensing section.

In the information processing method, similarly to the control device described above, it is possible to quantify the information on the collection success or the collection failure of the target object, and it is possible to further improve the work efficiency in collecting the target object and moving the target object to the accommodation section by using the quantified content. In the information processing method, various aspects of the above-described control device may be adopted, or a step for achieving each function of the above-described control device may be added.

The information processing method of the present disclosure is an information processing method to be executed by a computer, the information processing method being for use in a collection apparatus including a collection section configured to collect a target object with a collection member, and a sensing section configured to sense passage of the target object when the target object is accommodated in an accommodation section in which the target object collected by the collection section is stored, the information processing method includes:
a step of outputting estimation information in which a state of the collection member is estimated based on collection information on the collection of the target object and sensing information of the target object sensed by the sensing section.

In the information processing method, similarly to the control device described above, it is possible to acquire the information on the collection success or the collection failure of the target object using the collection member, and it is possible to further improve the work efficiency in collecting the target object and moving the target object to the accommodation section by estimating the state of the collection member. In the information processing method, various aspects of the above-described control device may be adopted, or a step for achieving each function of the above-described control device may be added.

### INDUSTRIAL APPLICABILITY

The present disclosure can be used in technical fields such as recycling of industrial waste.

Reference Signs List

10: recycling system, 10B: collection system, 12: process material,
13: waste material, 14: foreign matter, 14B: target object, 15: primary crusher, 16:
primary magnetic separator, 17: screening machine, 18: secondary crusher, 19:
secondary magnetic separator, 20 to 25, 22B: conveyance device, 26: supply device,
30: foreign matter removal device, 30B: collection apparatus, 31: detection section,
32, 32B: imaging section, 33: measurement section, 35: support portion, 36, 36B:
discarding section, 37, 37B: sensing section, 40: removal section, 40B: processing
section, 41: X-axis slider, 41B: arm robot, 43: Y-axis slider, 44: recognition section,
45, 45B: collection section, 46: lifting and lowering section, 48: removal head, 48B:
collection head, 49, 49B: collection member, 50, 50B: control device, 51: control
section, 52: storage section, 53: collection information, 54: sensing information, 55:
process information, 56: estimation information, 71: captured image, 72: captured
image, 80: notification screen, 81: cursor, 82: estimation information display field, 83:
process information display field, 84: confirmation key, D: conveyance direction, M:
worker.

1. A control device for use in a collection apparatus including a collection section configured to collect a target object with a collection member, and a sensing section configured to sense passage of the target object when the target object is accommodated in an accommodation section in which the target object collected by the collection section is stored, the control device comprising:
a control section configured to obtain process information on collection movement success of the target object and/or collection movement failure of the target object based on collection information on the collection of the target object and sensing information of the target object sensed by the sensing section.

2. A control device for use in a collection apparatus including a collection section configured to collect a target object with a collection member, and a sensing section configured to sense passage of the target object when the target object is accommodated in an accommodation section in which the target object collected by the collection section is stored, the control device comprising:
a control section configured to output estimation information in which a state of the collection member is estimated based on collection information on the collection of the target object and sensing information of the target object sensed by the sensing section.

3. The control device according to claim 1,
wherein the control section is configured to output estimation information in which a state of the collection member is estimated based on the obtained process information.

4. The control device according to claim 1,
wherein the control section is configured to use the collection information including the number of trials to try to collect the target object and/or the number of actual collections in which it was detected that the target object was collected.

5. The control device according to claim 1,
wherein the control section is configured to obtain the process information including a success rate and/or a success number from the collection information and the sensing information.

6. The control device according to claim 5,
wherein the control section is configured to output estimation information in which a state of the collection member is estimated when the obtained success rate and/or the obtained success number falls below a predetermined allowable value.

7. The control device according to claim 1,
wherein the control section is configured to obtain the process information including a failure rate and/or a failure number from the collection information and the sensing information.

8. The control device according to claim 7,
wherein the control section is configured to output estimation information in which a state of the collection member is estimated when the obtained failure rate and/or the obtained number of failures exceeds a predetermined limit value.

9. The control device according to claim 2,
wherein the control section is configured to output the estimation information including at least one of malfunction information including a malfunction diagnosis of the collection member, maintenance information for executing maintenance of the collection member, and inspection information for executing inspection of the collection member.

10. A foreign matter removal device as the collection apparatus, the foreign matter removal device comprising:
a collection section configured to collect a foreign matter as the target object with a collection member, the foreign matter being included in a process material conveyed by a conveyance device in a conveyance direction;
a sensing section configured to sense passage of the foreign matter when the foreign matter is accommodated in an accommodation section in which the foreign matter collected by the collection section is stored;
a detection section provided upstream of the collection section in the conveyance direction and configured to detect the foreign matter; and
the control device according to claim 1,
wherein the control section is configured to control the collection section based on a detection result of the detection section such that the foreign matter is collected and discarded to the accommodation section.

11. A collection apparatus comprising:
a collection section configured to collect a target object with a collection member;
a sensing section configured to sense passage of the target object when the target object is accommodated in an accommodation section in which the target object collected by the collection section is stored; and
the control device according to claim 1.

12. An information processing method to be executed by a computer, the information processing method being for use in a collection apparatus including a collection section configured to collect a target object with a collection member, and a sensing section configured to sense passage of the target object when the target object is accommodated in an accommodation section in which the target object collected by the collection section is stored, the information processing method comprising:
a step of obtaining process information on collection movement success of the target object and/or collection movement failure of the target object based on collection information on the collection of the target object and sensing information of the target object sensed by the sensing section.

13. An information processing method to be executed by a computer, the information processing method being for use in a collection apparatus including a collection section configured to collect a target object with a collection member, and a sensing section configured to sense passage of the target object when the target object is accommodated in an accommodation section in which the target object collected by the collection section is stored, the information processing method comprising:
a step of outputting estimation information in which a state of the collection member is estimated based on collection information on the collection of the target object and sensing information of the target object sensed by the sensing section.
